(19) United States
(12) Patent Application Publication
(10) Pub. No.: US 2003/0224145 A1
(43) Pub. Date: Dec. 4, 2003

(54) Thickness/weight profiled fibrous blanket; profiled density and/or thickness product; and method

(76) Inventors: Thomas Campion, Defiance, OH (US); Steven Arthur Cedoz, Hamler, OH (US); Dennis Robert Larratt, Littleton, CO (US)

Correspondence Address: Robert D. Touslee, Johns Manville Corporation, 10100 West Ute Avenue, Littleton, CO, 80127, US

(21) Appl. No.: 10/159,574

(22) Filed: May 31, 2002

(51) Int. Cl. B32B 17/00; B32B 1/00; B32B 31/08

(52) U.S. Cl. 428/171; 264/172.19; 156/62.2; 156/166; 428/218; 442/381; 428/219

(57) ABSTRACT

A fibrous blanket, formed with a profiled weight and thickness across the width and/or along the length of the blanket, may be used for various thermal and/or acoustical applications or formed through molding into a molded part having: a uniform thickness and variable density; a variable thickness and a uniform density; or a variable thickness and a variable density. When forming the fibrous blanket on a collection surface, the deposition of fibers on the collection surface is controlled, by manipulating the fiber containing gas stream and the fibers in the gas stream with secondary gas streams, to obtain a desired weight and thickness profile for the fibrous blanket.

### BACKGROUND OF THE INVENTION

The present invention relates to a fibrous blanket that may be used for numerous applications and that is especially suited for molding into various molded parts, and, in particular to a fibrous blanket, formed with a profiled weight and thickness across the width and/or along the length of the blanket, that may be used without further processing for certain applications or formed through molding into a molded part having: a uniform thickness and variable density; a variable thickness and a uniform density; or a variable thickness and a variable density. The present invention also relates to a method of and apparatus for making the fibrous blanket; a method and apparatus for molding the fibrous blanket into a molded part; and a molded part made from the fibrous blanket.

Fibrous blanket products are used for many applications and can be made from various fibers, such as glass fibers, mineral wool, or polymeric fibers. These fibrous blanket products can be made: with or without a binder; with a cured or uncured binder; as flexible low-density products; and as more rigid high-density products. Currently, these fibrous blanket products have a substantially uniform thickness and density throughout. Typically, such fibrous products are used as initially formed or after further processing, e.g. molding, cutting, etc., for thermal and/or acoustical insulating applications in homes; in commercial and industrial buildings; in office or room partitions; in heating, ventilating and air conditioning systems (HVAC), and in automobiles, trucks and other vehicles or means of transportation. These fibrous blanket products and products made from these fibrous blanket products, e.g. molded, grooved or cut fibrous blanket products, have performed quite well. However, there has been a need to improve these fibrous blanket products and the products made from these fibrous blanket products to reduce the labor and manufacturing costs related to these fibrous blanket products and the products made from these fibrous blanket products; to reduce the material costs and waste related to these fibrous blanket products and the products made from these fibrous blanket products; to improve the thermal and acoustical performance of these fibrous blanket products and the products made from these fibrous blanket products without increasing or while reducing the overall weight of these fibrous blanket products and products made from these fibrous blanket products; and/or to improve the strength of these fibrous blanket products and the products made from these fibrous blanket products where needed in the products without increasing the overall weight or while lowering the overall weight of the fibrous blanket products and the products made from the fibrous blanket products.

### SUMMARY OF THE INVENTION

The fibrous blanket products of the present invention; the products of the present invention formed from the fibrous blanket products of the present invention; and the apparatus and method of the present invention for making the fibrous blanket and molded or other products of the present invention from the fibrous blanket products of the present invention provide a solution to the needs outlined above.

The fibrous blanket of the present invention is a coherent mass of randomly oriented entangled fibers and has a profiled weight and thickness across the width of the blanket and/or along the length of the fibrous blanket. The fibrous blanket has first and second major surfaces that are each defined by the width and length of the fibrous blanket and first and second lateral edges. The first major surface of the fibrous blanket is substantially planar while the second major surface of the fibrous blanket is non-planar. Typically, the density of the fibrous blanket across the width and along the length of the fibrous blanket is uniform or constant or substantially uniform or constant. However, the weight and the thickness of the fibrous blanket vary, in a selected manner across the width of the fibrous blanket in a direction perpendicular to the first and second lateral edges and the longitudinal centerline of the fibrous blanket as a function of a perpendicular distance from the first lateral edge of the fibrous blanket and/or vary, in a selected manner along the length of the fibrous blanket in a direction parallel to the first and second lateral edges and the longitudinal centerline of the fibrous blanket, e.g. as a periodic function of the length of the fibrous blanket. In other words, the fibrous blanket has a profiled weight and thickness across the width and/or along the length of the fibrous blanket. The fibrous blanket may be faced with a sheet material, e.g. a kraft facing, a foil-scrim-kraft facing, a polymeric film-scrim-kraft facing, a polymeric film facing or similar facing material, or unfaced; and the fibrous blanket may be binderless or may include a cured binder or bonding fibers.

The fibrous blanket of the present invention may contain an uncured thermosetting or thermoplastic binder that can be cured or set during subsequent molding operations to hold a molded shape or bonding fibers that become tacky at a lower temperature than other fibers in the blanket and, when subjected to heat and pressure during molding and subsequent cooling, become tacky then solidify to bond the fibers of the blanket together to hold a molded shape. Where the fibrous blanket contains such a binder or bonding fibers, the fibrous blanket can be molded into a part having: a uniform thickness and variable density; a variable thickness and a uniform density; or a variable thickness and a variable density.

The method of making the fibrous blanket of the present invention with its profiled weight and thickness includes forming a fiber containing gas stream and directing the fiber containing gas stream toward a moving gas permeable collection conveyor. The fiber containing gas stream is manipulated as the fiber containing gas stream travels toward the gas permeable collection conveyor to collect the fibers on the moving gas permeable collection conveyor in selected varying amounts across the width of the gas permeable collection conveyor (in a direction perpendicular to the direction of movement of the gas permeable collection conveyor) to form a coherent randomly oriented entangled mass or blanket of the fibers. A first major surface of the fibrous blanket, that overlays and is adjacent the collection surface of the collection conveyor, is substantially planar while the second major surface of the fibrous blanket, that faces the fiber containing gas stream, is non-planar. The fibrous blanket collected has a weight per unit area of the first major surface of the fibrous blanket and a thickness that vary, in a selected manner across the width of the fibrous blanket in a direction perpendicular to the lateral edges of the fibrous blanket, as a function of a perpendicular distance from a first lateral edge of the fibrous blanket. Preferably, the fiber containing gas stream is manipulated by introducing one or more auxiliary or secondary gas streams into the previously formed fiber containing gas stream to distribute the fibers within the fiber containing gas stream in a selected manner as the gas stream approaches the collection surface of the moving gas permeable collection conveyor so that more fibers are deposited on selected parts of the moving gas permeable collection conveyor than other parts of the moving gas permeable collection conveyor, across the width of the collection surface of the gas permeable collection conveyor, to produce a fibrous blanket of varying weight per unit area and thickness across its width. By changing the speed of the conveyor in a predetermined manner, e.g. periodically speeding up the conveyor for a set period of time, the weight per unit area and the thickness of the fibrous blanket can be varied in a selected manner along the length of the fibrous blanket. The auxiliary gas streams could also be used to affect the fiber distribution in the longitudinal direction.

### BRIEF DESCRIPTION OF THE DRAWINGS

FIG. 1 is a partial schematic perspective view of a fibrous blanket of the present invention that has a low-high-low-high-low thickness and weight profile across the width of the fibrous blanket.

FIG. 2 is a partial schematic perspective view of a fibrous blanket of the present invention that has a profiled weight and thickness across the width of the fibrous blanket and along the length of the fibrous blanket.

FIG. 3 is a partial schematic perspective view of a fibrous blanket of the present invention having a low-high-low thickness and weight profile across the width of the fibrous blanket.

FIG. 4 is a schematic vertical cross section through a press with the fibrous blanket of FIG. 3 located intermediate the molding surfaces of the press prior to molding the fibrous blanket within the press.

FIG. 5 is a schematic vertical cross section through the press of FIG. 4 with the fibrous blanket of FIG. 3 located intermediate the molding surfaces of the press during the molding the fibrous blanket within the press.

FIG. 6 is a cross section of the molded part formed from the fibrous blanket of FIG. 3 in the press of FIGS. 4 and 5.

FIG. 7 is a schematic vertical cross section through a press for forming an automotive headliner with the fibrous blanket of FIG. 3 located intermediate the molding surfaces of the press prior to molding the fibrous blanket within the press.

FIG. 8 is a schematic vertical cross section through the press of FIG. 7 with the fibrous blanket of FIG. 3 located intermediate the molding surfaces of the press during the molding the fibrous blanket within the press.

FIG. 9 is a cross section of the molded automotive headliner part formed from the fibrous blanket of FIG. 3 in the press of FIGS. 7 and 8.

FIG. 10 is a partial schematic perspective view of a fibrous blanket of the present invention with a low-intermediate-high-intermediate-low thickness and weight profile across the width of the fibrous blanket.

FIG. 11 is a schematic vertical cross section through a press for forming an automotive headliner with the fibrous blanket of FIG. 10 located intermediate the molding surfaces of the press prior to molding the fibrous blanket within the press.

FIG. 12 is a schematic vertical cross section through the press of FIG. 11 with the fibrous blanket of FIG. 10 located intermediate the molding surfaces of the press during the molding the fibrous blanket within the press.

FIG. 13 is a cross section of the molded automotive headliner part formed from the fibrous blanket of FIG. 10 in the press of FIGS. 11 and 12.

FIG. 14 is a partial schematic perspective view of a fibrous blanket of the present invention that has a low-high-low-high-low-high-low-high thickness and weight profile across the width of the fibrous blanket.

FIG. 15 is a schematic vertical cross section through a press with the fibrous blanket of FIG. 14 located intermediate the molding surfaces of the press prior to molding the fibrous blanket within the press.

FIG. 16 is a schematic vertical cross section through the press of FIG. 15 with the fibrous blanket of FIG. 14 located intermediate the molding surfaces of the press during the molding the fibrous blanket within the press.

FIG. 17 is a cross section of the molded part formed from the fibrous blanket of FIG. 14 in the press of FIGS. 15 and 16.

FIG. 18 is a transverse cross section through an air duct formed by folding the molded part of FIG. 17 into a tubular shape with a rectangular transverse cross section.

FIG. 19 is a schematic elevation in cross section of an apparatus for use in forming the fibrous blanket of the present invention with its profiled weight and thickness.

FIG. 20 is a schematic plan view of the apparatus of FIG. 19.

FIG. 21 is a schematic elevation in cross section of an exit portion of the forming tube of the apparatus of FIGS. 19 and 20, in a larger scale, to better show the nozzles that emit the auxiliary or secondary gas streams into the fiber containing gas stream to manipulate the fiber containing gas stream.

FIG. 22 is a schematic perspective view of a nozzle assembly that emits an auxiliary or secondary gas stream for manipulating the fiber containing gas stream.

FIG. 23 is a graph with examples of two of the angles between 0° and 90° along which the auxiliary gas streams may be directed relative to the fiber containing gas stream.

FIG. 24 is a schematic plan view of the exit portion of the forming tube of the apparatus of FIGS. 19 and 20 showing a second arrangement of the nozzles that emit the auxiliary or secondary gas streams for manipulating the fiber containing gas stream.

FIG. 25 is a graph depicting various examples of weight and thickness profiles across the width of a fibrous blanket of the present invention.

### DESCRIPTION OF THE PREFERRED EMBODIMENT

The fibrous blanket of the present invention is a coherent mass of randomly oriented entangled fibers. While the preferred fibers forming the fibrous blanket of the present invention are glass fibers, the fibrous blanket of the present invention may be made of other fibers, such as but not limited to, rock wool fibers, slag fibers, and organic fibers e.g. polypropylene, polyester and other polymeric fibers. The fibrous blanket of the present invention may be binderless for certain applications or the fibrous blanket may include a cured binder such as but not limited to an urea phenol formaldehyde binder or another binder, e.g. a commercially available thermoplastic or thermosetting binder. When the fibrous blanket of the present invention is to be molded or otherwise further processed, the fibrous blanket typically includes an uncured binder, e.g. an urea phenol formaldehyde binder or another binder e.g. a commercially available thermoplastic or thermosetting binder, that is set or cured during the subsequent molding or other processing of the fibrous blanket. The fibrous blanket may also include a mixture or fibers wherein some of the fibers are thermoplastic or thermosetting bonding fibers that become tacky at a lower temperature than other fibers of the fibrous blanket. When the fibrous blanket is subsequently heated to this lower temperature and then cooled, as in a molding operation, the bonding fibers become tacky, bond to other fibers, and hold the fibers of the blanket together at their points of intersection when the fibers are subsequently cooled.

The fibrous blanket of the present invention typically has a substantially uniform or constant density throughout. The fibrous blanket of the present invention has two major surfaces. One major surface of the fibrous blanket is a substantially planar or flat major surface and the other major surface of the fibrous blanket is a profiled or uneven major surface caused by the variation in thickness and weight of the fibrous blanket across the width and/or along the length of the fibrous blanket. The weights of different portions of a fibrous blanket of the present invention, across the width and/or along the length of the fibrous blanket, may be measured in various ways. For example, the weights of different portions of a fibrous blanket of the present invention, across the width and/or along the length of the fibrous blanket may be measured by cutting out and removing each such portion of the fibrous blanket from a sample of the fibrous blanket. The area of the blanket portion removed from the planar or flat major surface of the fibrous blanket is determined and the weight of the blanket portion removed is determined. The area of the blanket portion is then divided into the weight of the blanket portion to obtain the weight of the blanket portion per unit area of the planar or flat major surface of the fibrous blanket. While other units of weight and area measurement may be used, typically, the units of weight per unit area of the fibrous blankets are given in grams per square foot. The fibrous blankets of the present invention typically have weights between about 30 grams per square foot and about 110 grams per square foot.

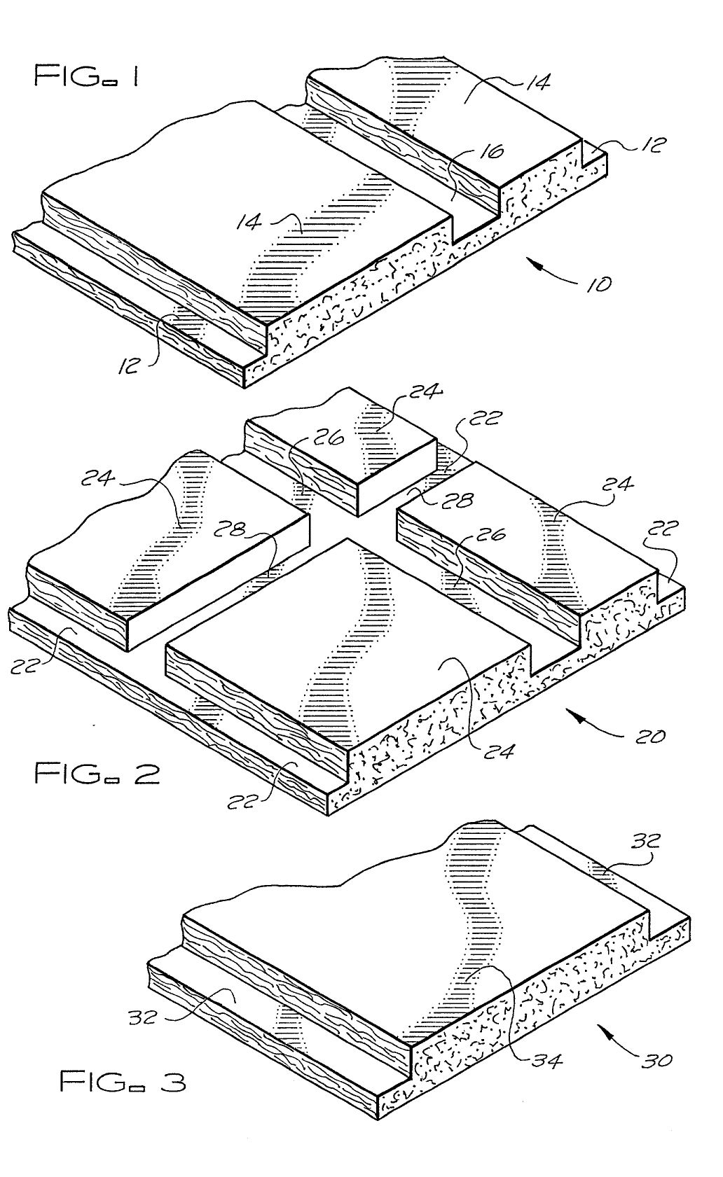

The fibrous blanket 10 of FIG. 1 is an example of a weight and thickness profiled fibrous blanket of the present invention that may be used to form various thermal and/or acoustical products. The fibrous blanket 10 normally has a uniform or substantially uniform density throughout. However, the weight and the thickness of the fibrous blanket 10 vary, in a selected or predetermined manner across the width of the fibrous blanket in a direction perpendicular to the first and second lateral edges of the fibrous blanket as a function of a perpendicular distance from a first lateral edge of the fibrous blanket.

The width of the fibrous blanket 10 that can be formed by the method and on the apparatus of the present invention is normally greater than the width of the products, e.g. thermal and/or acoustical insulation products, made from the fibrous blanket once the blanket is formed. The fibrous blanket 10 of FIG. 1 has a substantially uniform density throughout and has two low thickness and weight lateral edge portions 12, two high thickness and weight midportions 14, and a third low thickness and weight midportion 16 (the fibrous blanket 10 has a low-high-low-high-low thickness and weight profile across the width of the blanket). Where a product having or requiring the dimensions and the thickness and weight profile of the fibrous blanket 10 is being made, the fibrous blanket 10 may be used as is or further processed as a unit, e.g. faced, a binder cured, molded, etc. Where products having or requiring smaller dimensions and a different weight and thickness profile than the fibrous blanket 10 are being made from the fibrous blanket 10, such as two products having or requiring a narrower width and low-high-low thickness and weight profiles, the fibrous blanket 10 may be cut longitudinally along the middle of the third midportion 16 to form two fibrous blankets of the required dimensions and thickness and weight profile.

The fibrous blanket 20 of FIG. 2 is an example of a weight and thickness profiled fibrous blanket of the present invention that may be used to form various thermal and/or acoustical products. The fibrous blanket 20 normally has a uniform or substantially uniform density throughout. However, the weight and the thickness of the fibrous blanket 20 vary, in a selected or predetermined manner: a) across the width of the fibrous blanket in a direction perpendicular to the first and second lateral edges of the fibrous blanket as a function of a perpendicular distance from a first lateral edge of the fibrous blanket; and b) along the length of the fibrous blanket in a direction parallel to the first and second lateral edges of the fibrous blanket, e.g. as a periodic function of the length of the fibrous blanket. The fibrous blanket 20 of FIG. 2 has two low thickness and weight lateral edge portions 22, two high thickness and weight midportions 24, and a third low thickness and weight midportion 26 (the fibrous blanket 20 has a low-high-low-high-low thickness and weight profile across the width of the blanket). The fibrous blanket 20 also has longitudinally spaced apart low thickness and low weight transverse portions 28 that extend between the lateral edges of the blanket (the fibrous blanket 20 has a repeating low-high-low-high thickness and weight profile along the length of the blanket).

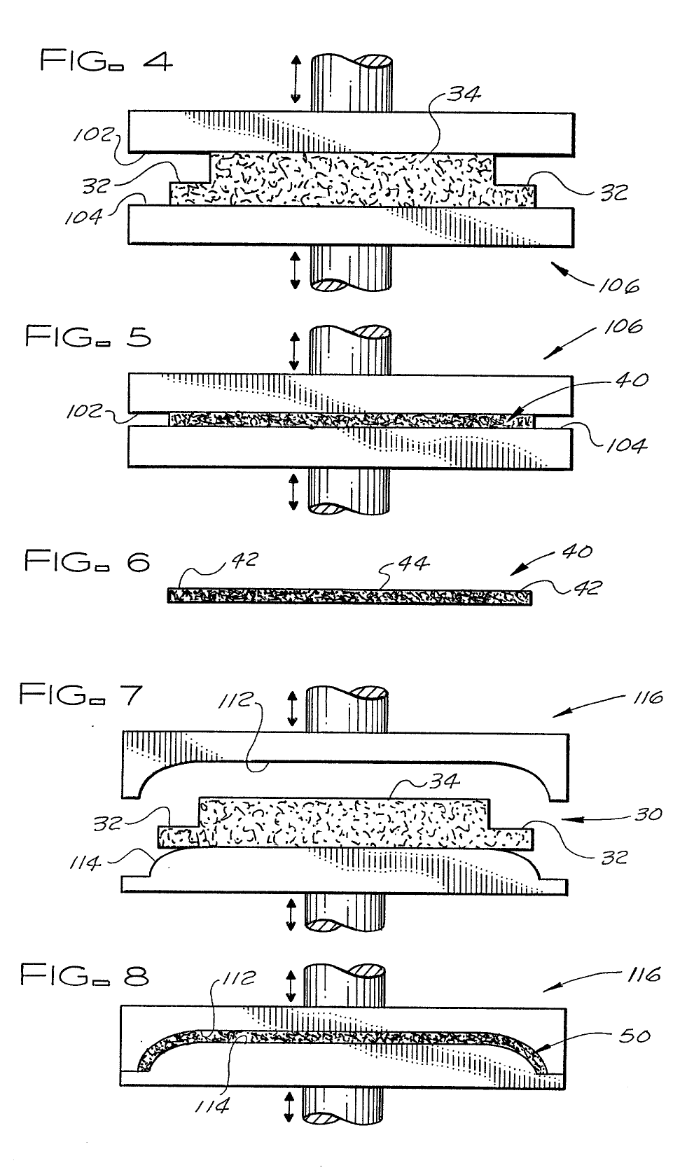

FIG. 3 shows a fibrous blanket 30 of the present invention that, typically, has a substantially uniform density throughout. The weight and the thickness of the fibrous blanket 30 vary, in a selected or predetermined manner across the width of the fibrous blanket in a direction perpendicular to the first and second lateral edges of the fibrous blanket as a function of a perpendicular distance from a first lateral edge of the fibrous blanket. The fibrous blanket 30 has two low thickness and low weight lateral edge portions 32 and a high thickness and high weight midportion 34. As schematically shown in FIGS. 4 and 5, the fibrous blanket 30 can be molded into the molded part 40 of FIG. 6. The molded part 40 has a constant thickness and variable density across the width of the molded part with two low-density lateral edge portions 42 formed from the lateral edge portions 32 of the fibrous blanket 30 and a high density midportion 44 formed from the midportion 34 of the fibrous blanket 30.

As shown in FIG. 4, the molded part 40 is formed by locating the fibrous blanket 30 intermediate the opposed, heated molding surfaces 102 and 104 of a conventional press 106. The opposed, heated molding surfaces 102 and 104 of the press 106 are then moved toward each other until, as shown in FIG. 5, the heated surfaces 102 and 104 of the press 106 reach a selected spacing equal to or substantially equal to the desired thickness of the molded part 40. At this spacing, the heated surfaces 102 and 104 of the press 106 place the fibrous blanket 30 under heat and pressure, shape the fibrous blanket, and, with a thermosetting binder, normally set or cure the binder within the fibrous blanket to form the molded part 40 with the desired shape or configuration, thickness and density profile. Where the fibrous blanket includes a thermoplastic binder or thermoplastic bonding fibers, the molded part would normally be cooled while in the mold to set the binder or bonding fibers so that the molded part 40 retains the desired shape and configuration.

One application for a molded part such as the molded part 40 is as a hoodliner in the engine compartment of an automobile or other motor vehicle. Glass fiber hoodliners are normally mounted beneath the hood a vehicle to reduce the transmission of engine noise from the engine compartment. A glass fiber hoodliner is typically installed by flexing the resilient lateral edges of the hoodliner; inserting the flexed edges of the hoodliners into retaining clips affixed to the hood of the automobile; and permitting the flexed edges of the hoodliner to snap back to their original unflexed state to hold the edges of the hoodliner in the retaining clips and mount the hoodliner to the hood of the automobile. Currently, the hoodliners used in automobiles and other motor vehicles have a uniform density and thickness throughout. To have the strength and rigidity required for spanning the underside of the hood between the retaining clips and to exhibit the desired acoustical properties, the midportions of these hoodliners need a certain minimum density. However, the density required for the midportions of these hoodliners extends out to the lateral edges of the hoodliners and makes the lateral edge portions of these hoodliners hard to flex and install due to the rigidity of the lateral edge portions. Thus, a hoodliner with lateral edge portions of a lesser density than the density of the midportion of the hoodliner, such as the molded part 40, would make the hoodliner easier to flex and install and would reduce breakage of the edge portions as the hoodliner is being installed. When used as a hoodliner, the high density midportion 44 of the hoodliner would typically be between about 30 and about 90 inches wide and the low-density lateral edge portions 42 would each be about 6 inches wide. As an example, to obtain a higher density the midportion 44 and lower density lateral edge portions 42 for such a hoodliner the midportion 34 of the blanket 30 could be about 90 grams/ft² while the lateral edge portions 32 of the blanket 30 could be about 40 grams/ft².

Headliners used to line the roofs in the passenger compartments of motor vehicles are another example of a molded part that is normally installed by flexing the resilient lateral edges of the headliner; inserting the flexed edges of the headliners into channels of the automobile roof structure; and permitting the flexed edges of the headliner to snap back to their original unflexed state to hold the edges of the headliner in the channels and mount the headliner to the automobile roof structure. Currently, the headliners typically used in automobiles and other motor vehicles have a uniform density throughout. To have the strength and rigidity required for spanning the underside of the automobile roofs between the mounting channels the midportions of these headliners need a certain minimum density. However, the density required for the midportions of these headliners extends out to the lateral edges of the headliners and makes the lateral edge portions hard to flex and install due to the rigidity of the lateral edge portions. Thus, a headliner with lateral edge portions of a lesser density than the midportion of the headliner would make the headliner easier to flex and install and would reduce breakage of the edge portions as the headliner is being installed.

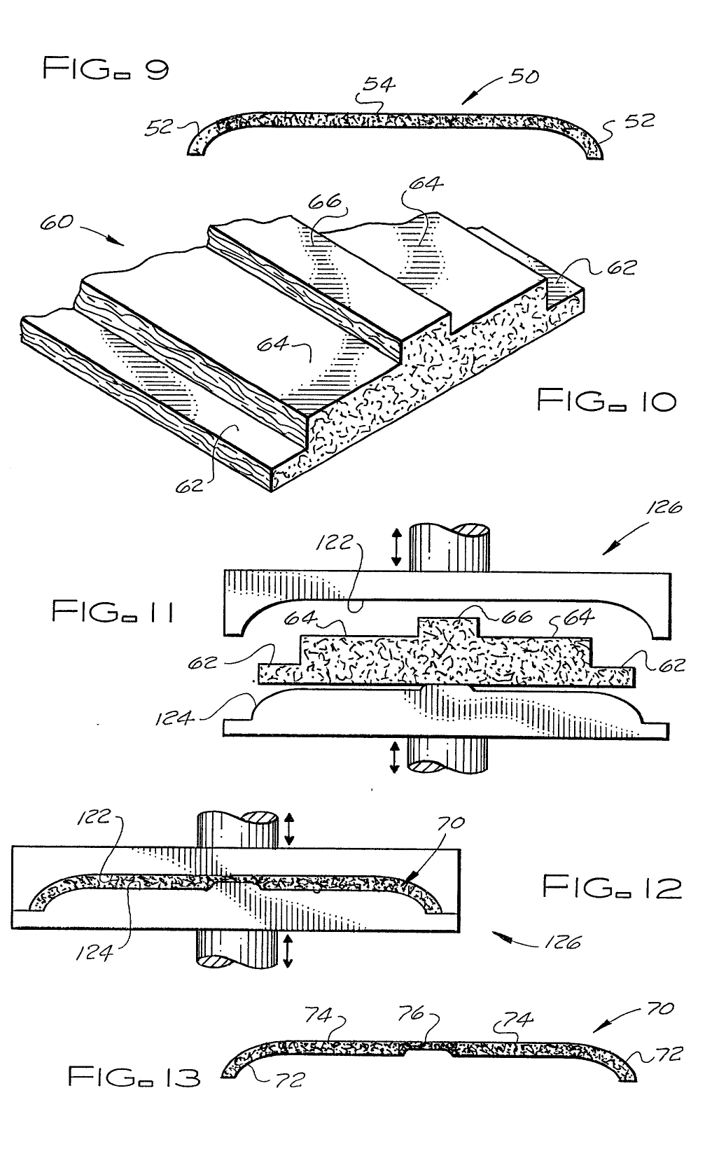

FIG. 9 shows a motor vehicle headliner 50, a molded part, made from the fibrous blanket 30 and FIGS. 7 and 8 schematically show the fibrous blanket 30 being molded into the molded motor vehicle headliner 50. As discussed above, the fibrous blanket 30 typically has a substantially uniform density throughout and the weight and the thickness of the fibrous blanket 30 vary, in a selected or predetermined manner across the width of the fibrous blanket in a direction perpendicular to the first and second lateral edges of the fibrous blanket as a function of a perpendicular distance from a first lateral edge of the fibrous blanket. The headliner 50 molded from the fibrous blanket 30 has a constant thickness and variable density across the width of the molded part. The headliner 50 has two low density lateral edge portions 52 formed from the lateral edge portions 32 of the fibrous blanket 30 and one high density midportion 54 formed from the midportion 34. When used as a headliner, the high density midportion 54 of the headliner would typically be between 50 and 77 inches wide and the low-density lateral edge portions 52 would each be about 6 inches wide. As an example, to obtain a higher density the midportion 54 and lower density lateral edge portions 52 for such a headliner the midportion 34 of the blanket 30 could be about 90 grams/ft² while the lateral edge portions 32 of the blanket 30 could be about 40 grams/ft².

As shown in FIG. 7, the molded headliner 50 is formed by locating the fibrous blanket 30 intermediate opposed, heated male and female molding surfaces 112 and 114 of a conventional press 116. The opposed, heated molding surfaces 112 and 114 of the press 116 are then moved toward each other until, as shown in FIG. 8, the heated surfaces 112 and 114 of the press 116 form a mold cavity having the selected shape and a spacing equal to or substantially equal to the desired thickness of the molded headliner 50. In this position, the heated surfaces 112 and 114 of the press 116 place the portion of the fibrous blanket 30 under heat and pressure, shape the fibrous blanket, and, where a thermosetting binder is used, normally set or cure the binder within the fibrous blanket to form the molded headliner 50 with the desired shape or configuration, thickness and density profile. Where the fibrous blanket 30 includes a thermoplastic binder or thermoplastic bonding fibers, the molded headliner 50 would normally be cooled while in the mold to set the binder or bonding fibers so that the molded headliner 50 retains the desired shape and configuration.

Frequently, headliners installed in passenger compartments beneath the roof of an automobile or other motor vehicle are used to help mount accessories beneath the roof of an motor vehicle such as videocassette consoles in vans and sports utility vehicles. The mounting of such accessories to these headliners may require these headliners to be formed with additional strength and rigidity in the region where the accessories are mounted at a thickness equal to or less than the thickness of the remainder of the midportion of the headliner.

FIG. 10 shows a fibrous blanket 60 of the present invention that, typically, has a substantially uniform density throughout. The weight and the thickness of the fibrous blanket 60 vary, in a selected or predetermined manner across the width of the fibrous blanket in a direction perpendicular to the first and second lateral edges of the fibrous blanket as a function of a perpendicular distance from a first lateral edge of the fibrous blanket. The fibrous blanket 60 has two low thickness and low weight lateral edge portions 62; two intermediate thickness and intermediate weight midportions 64, and a high thickness and high weight central portion 66.

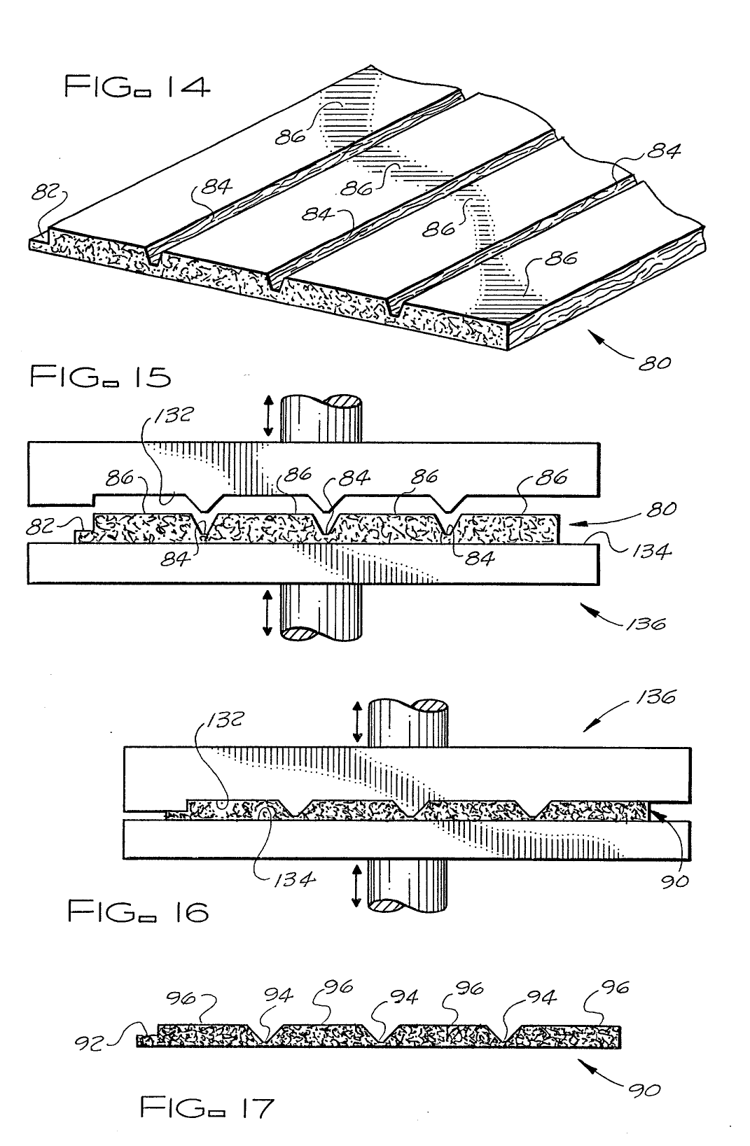

FIGS. 11 and 12 schematically show the fibrous blanket 60 being molded into a motor vehicle headliner 70, a molded part, having a variable thickness and variable density across the width of the molded part. As shown in FIG. 13, the molded headliner 70 has two low density lateral edge portions 72 formed from the lateral edge portions 62 of the fibrous blanket 60 and two intermediate density midportions 74 formed from the midportions 64 of the fibrous blanket that are the same thickness. The molded headliner 70 also includes a central portion 76 that has an even higher density than the midportions 74. With the greater thickness and weight of the central portion 66 of the fibrous blanket 60, the central portion 76 of the molded headliner 70 made from the central portion 66 of the fibrous blanket 60 would have a greater density than the midportions 74 of the molded part 70 for a thickness that is equal to, or less than the thickness of the midportions 74. As discussed above, when used as a headliner, the midportion 74 of the headliner would typically be between 50 and 77 inches wide and the lateral edge portions 72 would each be about 6 inches wide. As an example, to obtain the highest density for the central portion 76, an intermediate density the midportions 74 and the lowest density for the lateral edge portions 72 of the headliner 70, the central portion 66 of the blanket 60 could be about 110 grams/ft²; the midportions 64 of the blanket 60 could be about 90 grams/ft²; and the lateral edge portions 62 of the blanket 60 could be about 40 grams/ft².

As shown in FIG. 11, the molded headliner 70 is formed by locating the fibrous blanket 60 intermediate opposed, heated male and female molding surfaces 122 and 124 of a conventional press 126. The opposed, heated molding surfaces 122 and 124 of the press 126 are then moved toward each other until, as shown in FIG. 12, the heated surfaces 122 and 124 of the press 126 form a mold cavity having the selected shape and a spacing equal to or substantially equal to the desired thickness of the molded part 70. In this position, the heated surfaces 122 and 124 of the press 126 place the portion of the fibrous blanket 60 under heat and pressure, shape the fibrous blanket, and, where a thermosetting binder is used, normally set or cure the binder within the fibrous blanket to form the molded part 70 with the desired shape or configuration, thickness and density profile. Where the fibrous blanket 60 includes a thermoplastic binder or thermoplastic bonding fibers, the molded headliner 70 would normally be cooled while in the mold to set the binder or bonding fibers so that the molded headliner 70 retains the desired shape and configuration.

FIG. 14 shows a fibrous blanket 80 of the present invention that, typically, has a substantially uniform density throughout and that is intended to be molded into a duct board. The weight and the thickness of the fibrous blanket 80 vary, in a selected or predetermined manner across the width of the fibrous blanket in a direction perpendicular to the first and second lateral edges of the fibrous blanket as a function of a perpendicular distance from a first lateral edge of the fibrous blanket. The fibrous blanket 80 has a low thickness and low weight lateral edge portion 82, three low thickness and low weight portions 84 at the bases of V-shaped channels in the blanket, and four high thickness and high weight portions 86 (one of which includes the second lateral edge portion).

As schematically shown in FIGS. 15 and 16, the fibrous blanket 80 can be molded into the molded part 90 of FIG. 17. The molded part 90 has a variable thickness and variable density across the width of the molded part with a low density lateral edge portion 92 formed from the lateral edge portion 82 of the fibrous blanket 80, high density folding portions 94 at base of the V-shaped channels, and low density sidewall portions 96 formed from the portion 86 of the fibrous blanket 80.

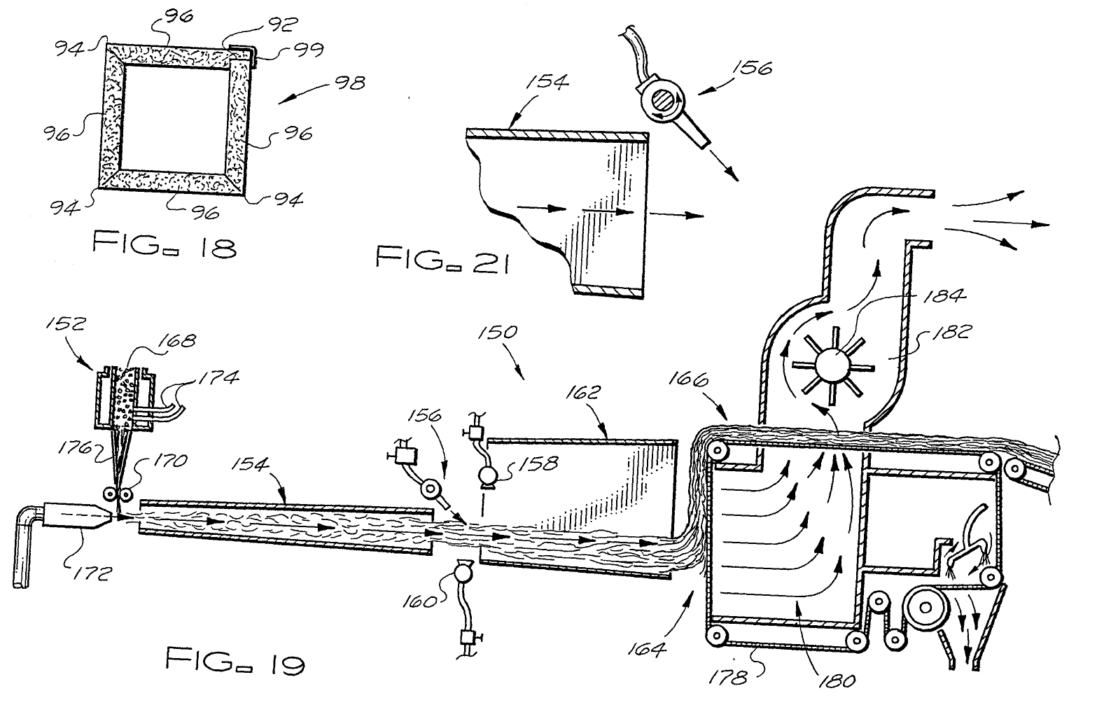

As shown in FIG. 15, the molded part 90 is formed by locating the fibrous blanket 80 intermediate the opposed, heated molding surfaces 132 and 134 of a conventional press 136. The opposed, heated molding surfaces 132 and 134 of the press 136 are then moved toward each other until, as shown in FIG. 16, the heated surfaces 132 and 134 of the press 136 reach a selected spacing equal to or substantially equal to the desired thicknesses of the molded part 90 with the portions 84 of the blanket being compressed to a high density and strength to form the folding portions 94 of the duct board and the walls of V-shaped channels being oriented at 90° to each other to enable the duct board to be folded into a tube having a rectangular transverse cross section. At this spacing, the heated surfaces 132 and 134 of the press 136 place the fibrous blanket 80 under heat and pressure, shape the fibrous blanket, and, with a thermosetting binder, normally set or cure the binder within the fibrous blanket to form the molded part 90 with the desired shape or configuration, thickness and density profile. Where the fibrous blanket 80 includes a thermoplastic binder or thermoplastic bonding fibers, the molded part 90 would normally be cooled while in the mold to set the binder or bonding fibers so that the molded part 90 retains the desired shape and configuration. FIG. 18 shows the molded duct board part 90 folded into an air duct 98 with a rectangular transverse cross section. The lateral edges of the duct board are taped or otherwise secured together with duct tape 99 to hold the duct board in its tubular shape.

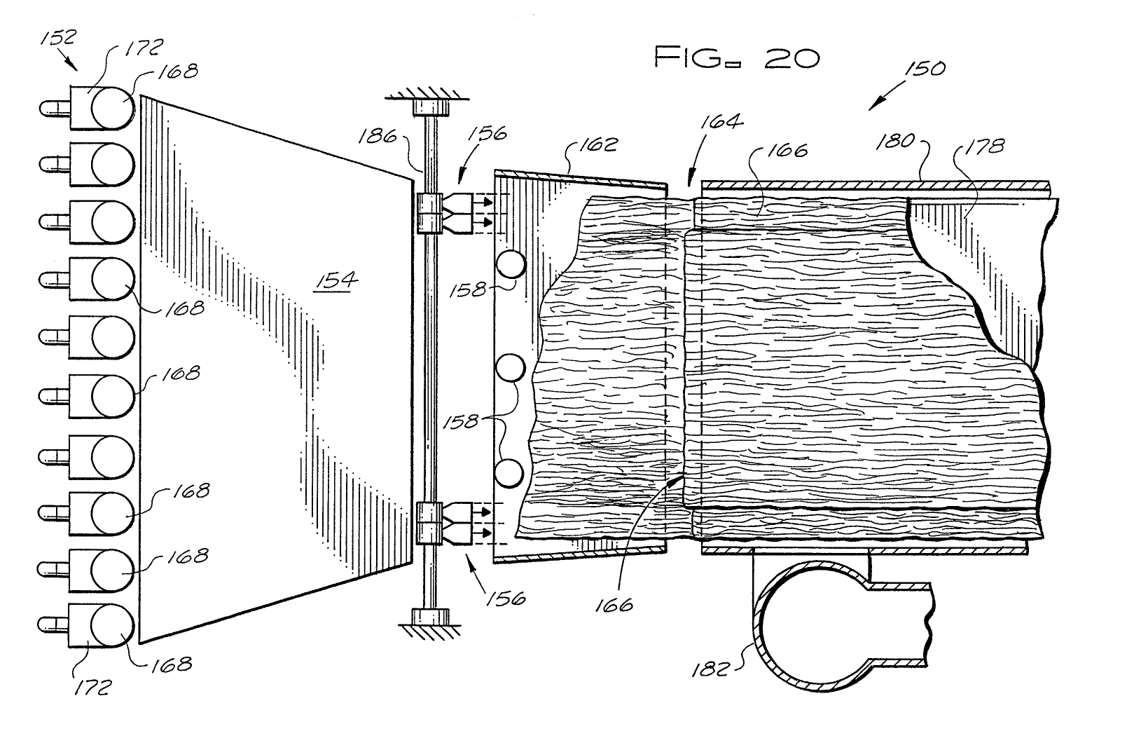

FIGS. 19 and 20 show an apparatus 150 for manufacturing fibrous blankets of the present invention from glass fibers. The apparatus 150 includes glass fiber generators 152; a forming tube 154; auxiliary or secondary air nozzle assemblies 156; binder and water application spray nozzles 158 and 160; a U-chute 162; and a collection station 164. For products where the fibrous blanket 166 formed in the collection station 164 is to be cured rather than being subjected to subsequent fabrication operations, such as molding operations, a conventional curing oven, not shown, is used to cure the binder in the fibrous blanket.

As best shown in FIG. 20, the glass fiber generators 152 are aligned across the width of the apparatus 150. While only ten glass fiber generators are shown, the number of glass fiber generators used can vary and it is also common to use twelve glass fiber generators. The glass fiber generators 150 each include a source of molten glass, such as the glass marble melting pots 168; pull rollers 170; and attenuation burners 172. The melting pots 168 receive glass marbles from a hopper, not shown. Each melting pot accepts the glass marbles on a demand basis. As the marbles melt, more marbles automatically flow into the melting pot to keep the pot full. A source of high-temperature thermal energy, such as burners 174, heats and melts the glass marbles within each melting pot until the viscosity of the melted glass is such that it is extruded through holes in the bottom of the melting pot to form primary continuous strands or filaments 176. These primary continuous filaments 176 are pulled from the melting pots 168 by the pull rollers 170 and fed in front of the attenuation burners 172. The attenuation burners 172 (preferably, commercially available gas/oxygen burning burners) direct hot gaseous blasts in a substantially horizontal direction that is perpendicular to the path of the continuous filaments 176 being fed in front of the burners. The hot gaseous blasts from the attenuation burners 172 attenuate the filaments and form them into finite length or staple glass fibers. These fibers are carried by the horizontally directed hot gas stream formed by the products of combustion issuing from the attenuation burners 172 through the forming tube 154, and the U-chute 162 to the collection surface of the air permeable collection conveyor 178 passing through the collection station 164.

Preferably, the auxiliary or secondary air nozzle assemblies 156, which direct streams of air into the fiber containing gas stream as the fiber containing gas stream exits the forming tube 154, are located adjacent the discharge or downstream end of the forming tube 154 and introduce the secondary air streams into the fiber containing gas stream intermediate the downstream end of the forming tube 154 and the upstream end of the U-chute 162. The operation of these auxiliary or secondary air nozzle assemblies will be described in detail below.

The binder application system, which normally includes the binder spray nozzles 158 and the water spray nozzles 160, is also normally located intermediate the downstream end of the forming tube 154 and the U-chute 162. The headers for the spray nozzles 158 and 160 extend across the width of the apparatus 150 with the binder spray nozzles 158 being located above the fiber containing gas stream passing through the forming tube 154 and the U-chute 162 and the water spray nozzles 160 being located below the fiber containing gas stream passing through the forming tube 154 and the U-chute 162. The nozzles 158 and 160 apply an atomized spray of binder and water, respectively, onto the glass fibers in the gas stream. When binder is applied to the glass fibers, the binder functions to bind the glass fibers in the fibrous blanket 166 together at their points of intersection either when the fibrous blanket is cured in its collected form by passing through a conventional curing oven further down the production line or when the fibrous blanket is further processed under heat and pressure, e.g. by molding, etc. into molded parts such as those shown and described above in connection with FIGS. 3 to 18. The water spray from the water spray nozzles cools down the hot fiber containing gas stream.

The collection conveyor 178 passing through the collection station 164 is a driven, endless, air permeable, chain mesh conveyor belt that passes over a series of guide rollers. A suction box 180 draws air in through the conveyor belt 178 causing the fibers to be collected into the blanket 166 on the vertically moving surface of the conveyor belt 178 as the conveyor belt moves through the collection station 164 in a substantially vertical direction perpendicular to the flow of the fiber containing gas stream. The air from the suction box 180 is exhausted through an exhaust stack 182 by an exhaust or suction fan 184. The fibrous blanket formed 166 formed on the collection conveyor 178 in the collection station 164 is conveyed downstream either through a conventional curing oven or to a discharge station where the fibrous blanket with its binder uncured is either packaged for shipment to a fabricator, e.g. to be molded and cured into a molded part at another location or immediately transferred to a fabrication line such a molding line.

As discussed above, preferably, the auxiliary or secondary air nozzle assemblies 156, which direct secondary streams of air into the fiber containing gas stream, as the fiber containing gas stream exits the forming tube 154, are located adjacent the discharge or downstream end of the forming tube 154 and introduce the secondary air streams into the fiber containing gas stream intermediate the downstream end of the forming tube 154 and the upstream end of the U-chute 162. The secondary air streams from the secondary air nozzles 156 are used to manipulate the fiber containing gas stream and the fibers in the gas stream to obtain a desired fiber distribution on the collection conveyer as the fibrous blanket 166 is formed on the collection conveyor to thereby form the fibrous blanket with a desired or predetermined thickness and weight profile across the width of the fibrous blanket and/or along the length of the fibrous blanket 166.

As shown in FIG. 20, the secondary air nozzles 156 are arrayed across the width of the downstream end of the forming tube 154 with a pair of secondary nozzles adjacent each lateral edge of the fiber containing gas stream exiting the forming tube. With the secondary nozzles 156 in these locations the fiber containing air stream and the fibers within the fiber containing air stream are manipulated to form a fibrous blanket 166 that has a low-high-low thickness and weight profile across the width of the fibrous blanket. The fibrous blanket 166 has a relatively low thickness and weight per unit area of the flat major surface of fibrous blanket along each lateral edge of the fibrous blanket and a relatively high thickness and weight per unit area of the flat major surface of the fibrous blanket intermediate the lateral edge portions of the fibrous blanket.

Preferably, the air nozzles 156 used for forming the fibrous blanket 166 with this type of low-high-low thickness and weight profile are of the type schematically shown in FIG. 22. An air nozzle, such as the air nozzle 156 shown in FIG. 22, emits an air stream in a flat concentrated column or pattern of substantially uniform width as represented by the dashed lines in FIG. 20. An air nozzle marketed by Spraying Systems Co. (www.spray.com) under the trade designation AA727 Windjet Nozzle, is an example of an air nozzle with such a spray pattern. Depending on the thickness and weight profile being sought across the fibrous blanket 166, the number and widths of the secondary air nozzles 156 used to manipulate the fiber containing air stream and the fibers in the air stream can vary and/or other air nozzles may be used in conjunction with or in lieu of the air nozzles 156 shown in FIGS. 19 to 22. For example, air nozzles may be used that emit a converging air stream and/or air nozzles may be used that emit a diverging air stream. In addition, any required number of secondary air nozzles can be arrayed across the width of the fiber containing air stream. FIG. 24 shows an example of an arrangement using three pairs of secondary air nozzles 156 for forming a fibrous blanket with a low-high-lowhigh-low thickness and weight profile across the width of the fibrous blanket.

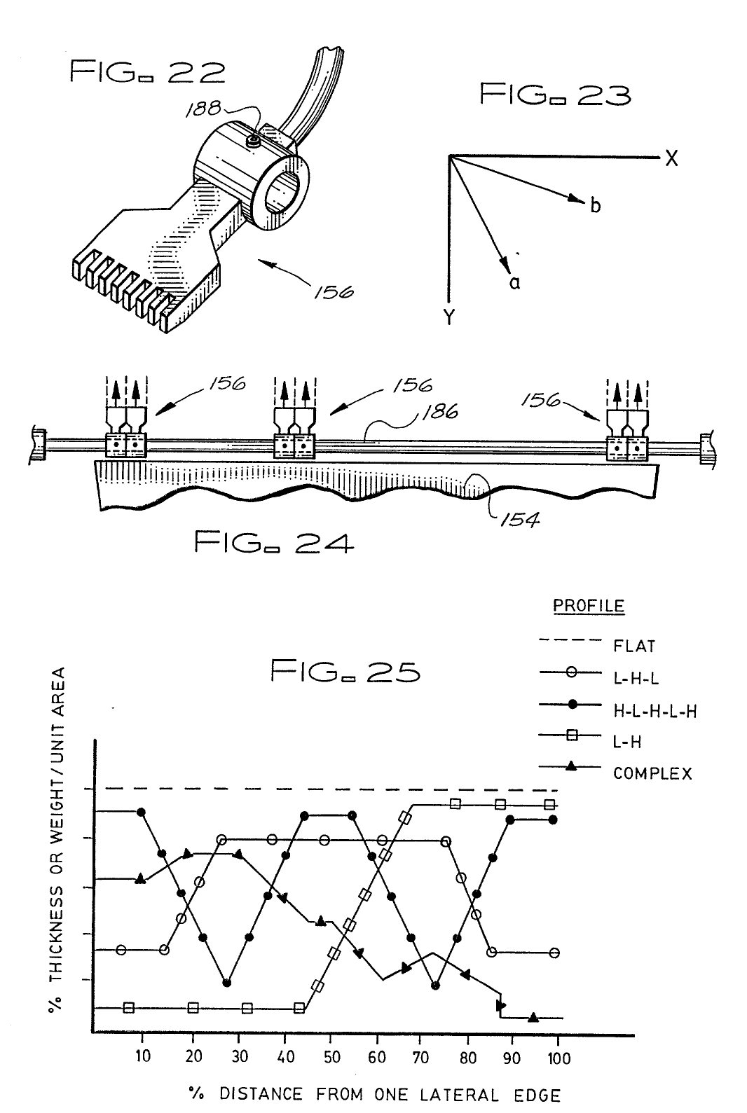

Typically, the air supplied to the air nozzles 156 is supplied at a pressure between 20 and 80-pounds/square inch, e.g. 40-pounds/square inch. Preferably, the air supplied to each of the secondary air nozzles is individually controlled, e.g. by valves, so that the volume and pressure of the air stream emitted by each individual secondary air nozzle can be regulated to obtain a fibrous blanket with the desired thickness and weight profile across the width of the fibrous blanket. The secondary air streams emitted by the secondary air nozzles 156 are directed in the same general direction as the fiber containing gas stream exiting the forming tube 154, but are inclined at an angle or at angles between parallel to and perpendicular to the direction of the fiber containing gas stream. In FIG. 23, the X-axis with its arrow represents the direction of flow of the fiber containing gas stream exiting the forming tube 154, the Y-axis is perpendicular to the direction of flow of the fiber containing gas stream exiting the forming tube 154, and the range of settings for the directions of the secondary air streams emitted by the secondary air nozzles 156 relative to the direction of flow of the fiber containing gas stream exiting the forming tube 154 is between 0° and 90°. At settings of or approaching 0° the secondary air streams would have little or no affect on the fiber containing gas stream exiting the forming tube 154. At settings of or approaching 90° the secondary gas streams would have the greatest affect on the fiber containing gas stream exiting the forming tube 154. The arrows “a” and “b” represent two of the infinite number of settings that could be used between 0° and 90°. While normally the secondary air streams are directed in the same general direction as the fiber containing gas stream exiting the forming tube 154, it is contemplated that there may be applications where at least some of the secondary air streams could be directed in a direction between 0° and 90° that is generally opposite to the direction of flow of the fiber containing gas stream exiting the forming tube 154. Preferably, each of the individual secondary air nozzles 156 can be adjusted about the support 186 and held in place, e.g. by a set screw 188, independently of the other secondary air nozzles to emit its secondary air stream at an angle selected to obtain the desired or predetermined thickness and weight profile across the width of the fibrous blanket.

With the apparatus and method of the present invention, a number of secondary air nozzles can be located across the width of the fiber containing gas stream at selected locations to form a fibrous blanket with the desired thickness and weight profile. The number, location(s), sizes, and type(s) of secondary air nozzles utilized can be selected; the supply of air (the pressure and volume of the air supplied) to the individual secondary air nozzles can be individually regulated; and the angle of the emitted secondary air streams from the individual secondary air nozzles relative to the direction of flow of the fiber containing gas stream can be independently set to produce any of a very large variety of thickness and weight profiled blankets. The graph of FIG. 25 schematically shows several examples of the general type of thickness and weight profiles for the fibrous blanket of the present invention. The dashed line represents a conventional uniform thickness and weight profile of fibrous blankets of the prior art. The graph lines with the zero, dot and square symbols thereon represent examples of relatively simple thickness and weight profiles for fibrous blankets of the present invention, while the graph line with the triangle symbols thereon represents an example of a complex thickness and weight profile for the fibrous blanket of the present invention.

As mentioned above and shown in FIG. 2, the thickness and weight profiled fibrous blankets of the present invention may also be thickness and weight profiled along their length by increasing the speed of the conveyor for a selected period of time to decrease the thickness and weight of the fibrous blanket, and/or decreasing the speed of the collection conveyor for a selected period of time to increase the thickness and weight of the fibrous blanket, and then returning the collection conveyor to its original or normal speed. In addition, to regulating the speed of the collection conveyor 178, the secondary air nozzles 156 can be utilized at the same time to manipulate the fiber containing gas stream and the fibers in the gas steam to obtain the desired thickness and weight profile.

In describing the invention, certain embodiments have been used to illustrate the invention and the practices thereof. However, the invention is not limited to these specific embodiments as other embodiments and modifications within the spirit of the invention will readily occur to those skilled in the art on reading this specification. Thus, the invention is not intended to be limited to the specific embodiments disclosed, but is to be limited only by the claims appended hereto.

What is claimed is:

1. A fibrous blanket with a profiled weight and thickness, comprising:
a fibrous blanket formed of a coherent mass randomly oriented entangled fibers; the fibrous blanket having a width, a length and a thickness; the fibrous blanket having first and second major surfaces that are each defined by the width and length of the fibrous blanket; the first major surface of the fibrous blanket being substantially planar; the second major surface of the fibrous blanket being non-planar; the fibrous blanket having first and second lateral edges that each extend between the first and second major surfaces of the fibrous blanket for the length of the fibrous blanket; the fibrous blanket having a weight per unit area of the first major surface of the fibrous blanket; and the weight of the fibrous blanket per unit area of the first major surface of the fibrous blanket and the thickness the fibrous blanket varying, in a selected manner across the width of the fibrous blanket, in a direction perpendicular to the first and second lateral edges of the fibrous blanket as a function of a perpendicular distance from the first lateral edge of the fibrous blanket.

2. The fibrous blanket according to claim 1, wherein:
the fibrous blanket has a first lateral edge portion adjacent the first lateral edge of the fibrous blanket, a second lateral edge portion adjacent the second lateral edge of the fibrous blanket, and a first mid-portion intermediate the first and second lateral edge portions of the fibrous blanket; and
the weight of the fibrous blanket per unit area of the first major surface of the fibrous blanket in the first lateral edge portion of the fibrous blanket and the thickness of the fibrous blanket in the first lateral edge portion of the fibrous blanket are less than the weight of the fibrous blanket per unit area of the first major surface of the fibrous blanket in the first mid-portion of the fibrous blanket and the thickness of the fibrous blanket in the first mid-portion of the fibrous blanket.

3. The fibrous blanket according to claim 2, wherein:
the fibrous blanket has a second mid-portion intermediate the first and second lateral edge portions of the fibrous blanket; and
the weight of the fibrous blanket per unit area of the first major surface of the fibrous blanket in the first lateral edge portion of the fibrous blanket and the thickness of the fibrous blanket in the first lateral edge portion of the fibrous blanket are less than the weight of the fibrous blanket per unit area of the first major surface of the fibrous blanket in the second mid-portion of the fibrous blanket and the thickness of the fibrous blanket in the second mid-portion of the fibrous blanket.

4. The fibrous blanket according to claim 3, wherein:
the fibrous blanket has a third mid-portion intermediate the first and second mid-portions of the fibrous blanket; and
the weight of the fibrous blanket per unit area of the first major surface of the fibrous blanket in the third mid-portion of the fibrous blanket and the thickness of the fibrous blanket in the third mid-portion of the fibrous blanket are less than the weight of the fibrous blanket per unit area of the first major surface of the fibrous blanket in the first mid-portion of the fibrous blanket and the thickness of the fibrous blanket in the first mid-portion of the fibrous blanket.

5. The fibrous blanket according to claim 4, wherein:
the weight of the fibrous blanket per unit area of the first major surface of the fibrous blanket in the third mid-portion of the fibrous blanket and the thickness of the fibrous blanket in the third mid-portion of the fibrous blanket are less than the weight of the fibrous blanket per unit area of the first major surface of the fibrous blanket in the second mid-portion of the fibrous blanket and the thickness of the fibrous blanket in the second mid-portion of the fibrous blanket.

6. The fibrous blanket according to claim 5, wherein:
the weight of the fibrous blanket per unit area of the first major surface of the fibrous blanket in the second lateral edge portion of the fibrous blanket and the thickness of the fibrous blanket in the second lateral edge portion of the fibrous blanket are less than the weights of the fibrous blanket per unit area of the first major surface of the fibrous blanket in the first and second mid-portions of the fibrous blanket and the thicknesses of the fibrous blanket in the first and second mid-portions of the fibrous blanket.

7. The fibrous blanket according to claim 2, wherein:
the weight of the fibrous blanket per unit area of the first major surface of the fibrous blanket in the second lateral edge portion of the fibrous blanket and the thickness of the fibrous blanket in the second lateral edge portion of the fibrous blanket are less than the weight of the fibrous blanket per unit area of the first major surface of the fibrous blanket in the first mid-portion of the fibrous blanket and the thicknesses of the fibrous blanket in the first portion of the fibrous blanket.

8. The fibrous blanket according to claim 1, wherein:
the fibrous blanket has a substantially uniform density throughout.

9. The fibrous blanket according to claim 1, wherein:
the fibrous blanket has a plurality of transverse portions spaced from each other along the length of the fibrous blanket; and
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from one of the transverse portions of the fibrous blanket to a next succeeding transverse portion of the fibrous blanket.

10. The fibrous blanket according to claim 1, wherein:
the fibrous blanket has first and second end edges; and
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from the first end edge of the fibrous blanket.

11. The fibrous blanket according to claim 2, wherein:
the fibrous blanket has first and second end edges;
the fibrous blanket has first and second end edge portions adjacent the first and second end edges;
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from the first end edge of the fibrous blanket; and
the weight of the fibrous blanket per unit area of the first major surface of the fibrous blanket in the first and second end portions of the fibrous blanket and the thickness of the fibrous blanket in the first and second end portions of the fibrous blanket are less than the weight of the fibrous blanket per unit area of the first major surface of the fibrous blanket in the first mid-portion of the fibrous blanket and the thicknesses of the fibrous blanket in the first portion of the fibrous blanket.

12. The fibrous blanket according to claim 1, wherein:
the fibrous blanket comprises glass fibers and the weight of the fibrous blanket per unit area of major surface of the first major surface ranges from about 30 gram/ft² to about 110 grams/ft².

13. The fibrous blanket according to claim 1, wherein:
the fibrous blanket includes an uncured binder that bonds fibers of the fibrous blanket together at points of intersection of the fibers within the fibrous blanket whereby, through a later application of heat and pressure the fibrous blanket, the fibrous blanket can be formed into and set in a desired shape having desired density and thickness characteristics.

14. The fibrous blanket according to claim 13, wherein:
the fibrous blanket comprises glass fibers and the weight of the fibrous blanket per unit area of major surface of the first major surface ranges from about 30 grams/ft² to about 110 grams/ft².

15. The fibrous blanket according to claim 13, wherein:
the fibrous blanket has a first lateral edge portion adjacent the first lateral edge of the fibrous blanket, a second lateral edge portion adjacent the second lateral edge of the fibrous blanket, and a first mid-portion intermediate the first and second lateral edge portions of the fibrous blanket; and
the weight of the fibrous blanket per unit area of the first major surface of the fibrous blanket in the first lateral edge portion of the fibrous blanket and the thickness of the fibrous blanket in the first lateral edge portion of the fibrous blanket are less than the weight of the fibrous blanket per unit area of the first major surface of the fibrous blanket in the first mid-portion of the fibrous blanket and the thickness of the fibrous blanket in the first mid-portion of the fibrous blanket.

16. The fibrous blanket according to claim 13, wherein:
the fibrous blanket has a second mid-portion intermediate the first and second lateral edge portions of the fibrous blanket; and
the weight of the fibrous blanket per unit area of the first major surface of the fibrous blanket in the first lateral edge portion of the fibrous blanket and the thickness of the fibrous blanket in the first lateral edge portion of the fibrous blanket are less than the weight of the fibrous blanket per unit area of the first major surface of the fibrous blanket in the second mid-portion of the fibrous blanket and the thickness of the fibrous blanket in the second mid-portion of the fibrous blanket.

17. The fibrous blanket according to claim 16, wherein:
the fibrous blanket has a third mid-portion intermediate the first and second mid-portions of the fibrous blanket; and
the weight of the fibrous blanket per unit area of the first major surface of the fibrous blanket in the third mid-portion of the fibrous blanket and the thickness of the fibrous blanket in the third mid-portion of the fibrous blanket are less than the weight of the fibrous blanket per unit area of the first major surface of the fibrous blanket in the first mid-portion of the fibrous blanket and the thickness of the fibrous blanket in the first mid-portion of the fibrous blanket.

18. The fibrous blanket according to claim 17, wherein:
the weight of the fibrous blanket per unit area of the first major surface of the fibrous blanket in the third mid-portion of the fibrous blanket and the thickness of the fibrous blanket in the third mid-portion of the fibrous blanket are less than the weight of the fibrous blanket per unit area of the first major surface of the fibrous blanket in the second mid-portion of the fibrous blanket and the thickness of the fibrous blanket in the second mid-portion of the fibrous blanket.

19. The fibrous blanket according to claim 18, wherein:
the weight of the fibrous blanket per unit area of the first major surface of the fibrous blanket in the second lateral portion of the fibrous blanket and the thickness of the fibrous blanket in the second lateral edge portion of the fibrous blanket are less than the weights of the fibrous blanket per unit area of the first major surface of the fibrous blanket in the first and second mid-portions of the fibrous blanket and the thicknesses of the fibrous blanket in the first and second mid-portions of the fibrous blanket.

20. The fibrous blanket according to claim 13, wherein:
the weight of the fibrous blanket per unit area of the first major surface of the fibrous blanket in the second lateral edge portion of the fibrous blanket and the thickness of the fibrous blanket in the second lateral edge portion of the fibrous blanket are less than the weight of the fibrous blanket per unit area of the first major surface of the fibrous blanket in the first mid-portion of the fibrous blanket and the thicknesses of the fibrous blanket in the first portion of the fibrous blanket.

21. The fibrous blanket according to claim 13, wherein:
the fibrous blanket has a substantially uniform density throughout.

22. The fibrous blanket according to claim 13, wherein:
the fibrous blanket has a plurality of transverse portions spaced from each other along the length of the fibrous blanket; and
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from one of the transverse portions of the fibrous blanket to a next succeeding transverse portion of the fibrous blanket.

23. The fibrous blanket according to claim 13, wherein:
the fibrous blanket has first and second end edges; and
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from the first end edge of the fibrous blanket.

24. The fibrous blanket according to claim 14, wherein:
the fibrous blanket has first and second end edges;
the fibrous blanket has first and second end edge portions adjacent the first and second end edges;
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from the first end edge of the fibrous blanket; and
the weight of the fibrous blanket per unit area of the first major surface of the fibrous blanket in the first and second end portions of the fibrous blanket and the thickness of the fibrous blanket in the first and second end portions of the fibrous blanket are less than the weight of the fibrous blanket per unit area of the first major surface of the fibrous blanket in the first mid-portion of the fibrous blanket and the thicknesses of the fibrous blanket in the first portion of the fibrous blanket.

25. A method of making a fibrous blanket with a profiled weight and thickness, comprising:
forming a fiber containing gas stream;
directing the fiber containing gas stream toward a moving gas permeable collection conveyor;
manipulating the fiber containing gas stream as the fiber containing gas stream travels toward the gas permeable collection conveyor to collect the fibers, in selected varying amounts, across a width of the gas permeable collection conveyor that is perpendicular to the direction of movement of the gas permeable collection conveyor, to form a fibrous blanket; the fibrous blanket being a coherent randomly oriented entangled mass of the fibers; the fibrous blanket having a width, a length and a thickness; the fibrous blanket having first and second major surfaces that are each defined by the width and length of the fibrous blanket; the first major surface of the fibrous blanket being substantially planar; the second major surface of the fibrous blanket being non-planar; the fibrous blanket having first and second lateral edges that each extend between the first and second major surfaces of the fibrous blanket for the length of the fibrous blanket; the fibrous blanket having a weight per unit area of the first major surface of the fibrous blanket; and the weight of the fibrous blanket per unit area of the first major surface of the fibrous blanket and the thickness the fibrous blanket varying, in a selected manner across the width of the fibrous blanket, in a direction perpendicular to the first and second lateral edges of the fibrous blanket as a function of a perpendicular distance from the first lateral edge of the fibrous blanket.

26. The method of making a fibrous blanket with a profiled weight and thickness according to claim 25, wherein:
the fiber containing gas stream is formed from products of combustion produced in the formation of the fibers and the fiber containing gas stream is manipulated, as the fiber containing gas stream travels toward the gas permeable collection conveyor, to deposit higher amounts of the fibers on certain areas of the gas permeable collection conveyor than others, by means located downstream from where the fiber containing gas stream is formed.

27. The method of making a fibrous blanket with a profiled weight and thickness according to claim 25, wherein:
the fiber containing gas stream is manipulated, as the fiber containing gas stream travels toward the gas permeable collection conveyor, to deposit higher amounts of the fibers on certain areas of the gas permeable collection conveyor than others, by introducing secondary gas streams into the fiber containing gas stream downstream from where the fiber containing gas stream is formed.

28. The method of making a fibrous blanket with a profiled weight and thickness according to claim 25, wherein:
a binder for bonding fibers of the fibrous blanket together at points of intersection of the fibers within the fibrous blanket is introduced into the fiber containing gas stream and left uncured within the fibrous blanket whereby, through a later application of heat and pressure to the fibrous blanket, the fibrous blanket can be formed into and set in a desired shape having desired density and thickness characteristics.

29. The method of making a fibrous blanket with profiled weight and thickness according to claim 25, wherein:
the fibrous blanket is formed with a substantially uniform density throughout.

30. The method of making a fibrous blanket with profiled weight and thickness according to claim 25, wherein:
the fibrous blanket is formed of glass fibers and the weight of the fibrous blanket per unit area of major surface of the first major surface ranges from about 30 grams/ft² to about 110 grams/ft².

31. The method of making a fibrous blanket with a profiled weight and thickness according to claim 25, wherein:
the fiber containing gas stream is manipulated as the fiber containing gas stream travels toward the gas permeable collection conveyor to collect the fibers in selected varying amounts along a length of the gas permeable collection conveyor to form a plurality of transverse portions spaced from each other along the length of the fibrous blanket; and
the weight of the fibrous blanket per unit area of the first major surface of the fibrous blanket and the thickness the fibrous blanket vary, in a selected manner along the length of the fibrous blanket, in a direction parallel to the first and second lateral edges of the fibrous blanket as a function of a perpendicular distance from one of the transverse portions of the fibrous blanket to a next succeeding transverse portion of the fibrous blanket.

32. The method of making a fibrous blanket with a profiled weight and thickness according to claim 31, wherein:
a binder for bonding fibers of the fibrous blanket together at points of intersection of the fibers within the fibrous blanket is introduced into the fiber containing gas stream and left uncured within the fibrous blanket whereby, through a later application of heat and pressure to the fibrous blanket, the fibrous blanket can be formed into and set in a desired shape having desired density and thickness characteristics.

33. The method of making a fibrous blanket with profiled weight and thickness according to claim 32, wherein:
the fibrous blanket is formed with a substantially uniform density throughout.

34. The method of making a fibrous blanket with profiled weight and thickness according to claim 32, wherein:
the fibrous blanket is formed of glass fibers and the weight of the fibrous blanket per unit area of major surface of the first major surface ranges from about 30 grams/ft² to about 110 grams/ft².

35. A method of making a molded part, comprising:
forming a fibrous blanket; the fibrous blanket being a coherent randomly oriented entangled mass of the fibers; the fibrous blanket containing an uncured binder for bonding fibers of the fibrous blanket together at their points of intersection; the fibrous blanket having a width, a length and a thickness; the fibrous blanket having first and second major surfaces that are each defined by the width and length of the fibrous blanket; the first major surface of the fibrous blanket being substantially planar; the second major surface of the fibrous blanket being non-planar; the fibrous blanket having first and second lateral edges that each extend between the first and second major surfaces of the fibrous blanket for the length of the fibrous blanket; the fibrous blanket having a weight per unit area of the first major surface of the fibrous blanket; and the weight of the fibrous blanket per unit area of the first major surface of the fibrous blanket and the thickness the fibrous blanket varying, in a selected manner across the width of the fibrous blanket, in a direction perpendicular to the first and second lateral edges of the fibrous blanket as a function of a perpendicular distance from the first lateral edge of the fibrous blanket;
locating the fibrous blanket between mold sections that, when brought together, have spaced apart opposing surfaces that form a mold cavity having a desired configuration for the molded part;
compressing the fibrous blanket between the mold sections, to shape the fibrous blanket to conform to the configuration of the mold cavity, by bringing the mold sections together with the fibrous blanket located between the mold sections; and
at least partially setting the binder within the fibrous blanket, while the fibrous blanket is compressed between the mold sections, sufficiently to cause the fibrous blanket to substantially retain the configuration of the mold cavity after the fibrous blanket is removed from the mold cavity as the molded part.

36. The method of making a molded part according to claim 35, wherein:
the fibrous blanket is formed with a substantially uniform density throughout.

37. The method of making a molded part according to claim 36, wherein:
the spacing between opposed surfaces of the mold sections is substantially constant and the molded part is formed with a substantially constant thickness; and
the molded part is formed with a density that varies across the width of the molded part with portions of the molded part, formed from portions of the fibrous blanket having a weight per unit area of major surface of the first major surface of the fibrous blanket less than other portions of the fibrous blanket, having a lower density than other portions of the molded part formed from the other portions of the fibrous blanket.

38. The method of making a molded part according to claim 36, wherein:
throughout the mold cavity and throughout the fibrous blanket located within the mold cavity the spacing between the opposed surfaces of the mold sections coincides substantially with but is less than the thickness of the fibrous blanket; and
the molded part is formed with a substantially constant density across the width of the molded part.

39. The method of making a molded part according to claim 38, wherein:
the configuration of the mold cavity is substantially the same as a configuration of the fibrous blanket prior to being located between the mold sections.

40. The method of making a molded part according to claim 36, wherein:
the spacing between opposed surfaces of the mold sections varies and forms a molded part that varies in thickness and density across the width of the molded part.

41. The method of making a molded part according to claim 35, wherein:
the fibers are glass fibers, the binder is a resin; and the binder is at least partially set within the mold by the application of heat to the fibrous blanket.

42. The method of making a molded part according to claim 35, wherein:
the fibrous blanket is formed with a substantially constant density throughout;
the fibrous blanket is formed with a first lateral edge portion adjacent the first lateral edge of the fibrous blanket, a second lateral edge portion adjacent the second lateral edge of the fibrous blanket, and a mid-portion intermediate the first and second lateral edge portions of the fibrous blanket;
the weight of the fibrous blanket per unit area of the first major surface of the fibrous blanket in the first and second lateral edge portions of the fibrous blanket and the thickness of the fibrous blanket in the first and second lateral edge portions of the fibrous blanket are less than the weight of the fibrous blanket per unit area of the first major surface of the fibrous blanket in the mid-portion of the fibrous blanket and the thickness of the fibrous blanket in the mid-portion of the fibrous blanket;
the spacing between opposed surfaces of the mold sections is substantially constant and the molded part is formed with a substantially constant thickness and with a density in the mid-portion that is greater than densities of the lateral edge portions.

43. The method of making a molded part according to claim 42, wherein:
the fibers are glass fibers, the binder is a resin; and the binder is at least partially set within the mold by the application of heat to the fibrous blanket.

44. An apparatus for forming a fibrous blanket with a profiled weight and thickness, comprising:
a gas permeable collection conveyor; the gas permeable collection conveyor having a width and a length; drive means for moving the gas permeable collection conveyor in a direction perpendicular to the width of the gas permeable collection conveyor;
means for drawing gases through the gas permeable collection conveyor in a direction from an outer fiber collection surface of the gas permeable collection conveyor to an inner surface of the gas permeable collection conveyor;
means for creating a fiber containing gas stream and directing the fiber containing gas stream toward the outer fiber collection surface of the gas permeable collection conveyor; and
means for manipulating the fiber containing gas stream as the fiber containing gas stream travels toward the outer collection surface of gas permeable collection conveyor to collect the fibers in selected varying amounts across a width of the gas permeable collection conveyor, perpendicular to the direction of movement of the gas permeable collection conveyor, to form a fibrous blanket; the fibrous blanket being a coherent randomly oriented entangled mass of the fibers; the fibrous blanket having a width, a length and a thickness; the fibrous blanket having first and second major surfaces that are each defined by the width and length of the fibrous blanket; the first major surface of the fibrous blanket being substantially planar; the second major surface of the fibrous blanket being non-planar; the fibrous blanket having first and second lateral edges that each extend between the first and second major surfaces of the fibrous blanket for the length of the fibrous blanket; the fibrous blanket having a weight per unit area of the first major surface of the fibrous blanket; and the weight of the fibrous blanket per unit area of the first major surface of the fibrous blanket and the thickness the fibrous blanket varying, in a selected manner across the width of the fibrous blanket, in a direction perpendicular to the first and second lateral edges of the fibrous blanket as a function of a perpendicular distance from the first lateral edge of the fibrous blanket.

45. The apparatus for making a fibrous blanket with a profiled weight and thickness according to claim 44, wherein:
the fiber containing gas stream contains products of combustion produced in the formation of the fibers and the gas stream is manipulated, as the fibers travel toward the gas permeable collection conveyor, to deposit higher amounts of the fibers on certain areas of the gas permeable collection conveyor than others, by means located downstream from where the fiber containing gas stream is formed.

46. The apparatus for making a fibrous blanket with a profiled weight and thickness according to claim 44, wherein:
the fiber containing gas stream is manipulated, as the fiber containing gas stream travels toward the gas permeable collection conveyor, to deposit higher amounts of the fibers on certain areas of the gas permeable collection conveyor than others, by introducing secondary gas streams into the fiber containing gas stream downstream from where the fiber containing gas stream is formed.

47. The apparatus for making a fibrous blanket with a profiled weight and thickness according to claim 44, including:
means for applying a binder to the fibers in the fiber containing gas stream while the fibers are traveling toward the gas permeable collection conveyor.

48. The apparatus for making a fibrous blanket with a profiled weight and thickness according to claim 44, wherein:
the means for creating the fiber containing gas stream are burners that form glass fibers from glass filaments introduced into flames discharged from the burners.
